(19) United States
(12) Patent Application Publication
(10) Pub. No.: US 2025/0326042 A1
(43) Pub. Date: Oct. 23, 2025

(54) Handheld work apparatus

(71) Applicant: Andreas Stihl AG & Co. KG, Waiblingen (DE)

(72) Inventors: Patrick Schindler, Weilheim an der Teck (DE); Denis Ehrler, Wernau (DE); Jürgen Hohl, Wabilingen (DE); Fabian Willems, Stuttgart (DE); Tobias Wagner, Berglen (DE)

(73) Assignee: Andreas Stihl AG & Co. KG, Waiblingen (DE)

(21) Appl. No.: 19/184,026

(22) Filed: Apr. 21, 2025

(30) Foreign Application Priority Data
Apr. 23, 2024 (DE) 102024111427.4

(51) Int. Cl. B23D 59/00; B23D 45/16; B23D 47/00

(52) U.S. Cl. CPC B23D 59/00; B23D 45/16; B23D 47/005

(57) ABSTRACT

A handheld work apparatus includes a housing (2). A drive motor (3) is arranged in the housing (2) for driving a tool (2) that rotates about an axis of rotation (8). A protective hood (51) at least partially covers the tool (5). An operating stop (120) is fixed relative to the housing (2) and a counter-body (110) is arranged on the protective hood (51) and corresponds to the operating stop (120). The operating stop (120) is designed as an energy absorption element which, in the event of an excess load acting on the operating stop (120) due to the counter-body (110), moves away from the counter-body (110) in order to absorb kinetic energy of the protective hood (51) and to protect components of the counter-body (110). The work apparatus (1) includes an end stop (101) for restricting the rotational movement of the protective hood (51) to an end position (25).

### CROSS-REFERENCE TO RELATED APPLICATION

This application claims the benefit of German Patent Application DE 102024111427.4, filed on Apr. 23, 2024, the content of which is incorporated in its entirety.

### TECHNICAL FIELD

The disclosure relates to a handheld work apparatus.

### BACKGROUND

A handheld work apparatus, in particular a cut-off machine, is known, which comprises a housing, a drive motor arranged in the housing for driving a tool that rotates about an axis of rotation. The work apparatus comprises a protective hood, the protective hood at least partially covering the tool. Furthermore, the work apparatus comprises an operating stop and a counter-body arranged on the protective hood and corresponding to the operating stop.

A standard requirement for such a work apparatus is, among others, a so-called burst test. In a burst test, a scenario is presented in which the cutting wheel breaks into multiple parts during operation of the work apparatus, which are then caught by the protective hood. Standards stipulate that the protective hood absorbs the kinetic energy of the cutting wheel parts, but the freedom of movement of the protective hood is limited.

### SUMMARY

It is an object of the disclosure to specify a handheld work apparatus, which, via the protective hood, reliably absorbs the kinetic energy of individual cutting wheel parts that get into the protective hood and which reliably dissipates the kinetic energy of the protective hood.

This object is solved by a handheld work apparatus as disclosed and claimed.

The handheld work apparatus comprises: a housing; a drive motor arranged in the housing for driving a tool that rotates about an axis of rotation; a protective hood, the protective hood at least partially covering the tool; an operating stop fixed relative to the housing; and a counter-body arranged on the protective hood and corresponding to the operating stop. The operating stop is designed as an energy absorption element which, in the event of an excess load acting on the operating stop due to the counter-body, moves away from the counter-body in order to absorb kinetic energy of the protective hood and to protect components of the counter-body. The work apparatus comprises an end stop for restricting the rotational movement of the protective hood to an end position.

The operating stop of the work apparatus is used to restrict the pivoting movement of the protective hood. The latter can preferably be pivoted from a first operating position into a second operating position. The operating stop of the work apparatus restricts the pivoting movement of the protective hood to the second operating position. A pivoting movement of the protective hood from the first operating position beyond the second operating position is not provided. In the event of a burst test, however, the kinetic energy of the protective hood may be so high that the pivoting movement of the protective hood can no longer be completely stopped or restricted by the operating stop together with the counter-body. Therefore, the operating stop is designed in such a way that it absorbs, via the counter-body, so much kinetic energy of the protective hood that the pivoting movement of the protective hood is at least restricted to the end position via the end stop. This therefore ensures that the pivoting movement of the protective hood is reliably restricted even if the tool ruptures, as in the burst test. Because the operating stop moves away from the counter-body in the case of excess load, it can furthermore be ensured that the counter-body is not damaged. This evasion can be achieved, for example, by means of a predetermined breaking point in the operating stop, which breaks in the event of excess load. The operating stop moving away from the counter-body can also be implemented, for example, via material deformation of the operating stop, which occurs when the counter-body hits the operating stop. The material can deform elastically and/or plastically. Further designs of the operating stop are conceivable, which allow the operating stop to move away from the counter-body in the event of an excess load occurring on the counter-body.

It is in particular provided that a further counter-body corresponding to the end stop is provided on the protective hood, wherein the further counter-body is formed in particular integrally on the protective hood. The counter-body and the further counter-body are arranged at different positions on the protective hood. The counter-body can also be formed integrally on the protective hood. An integral design of counter-body and/or further counter-body with the protective hood is particularly advantageous if the protective hood is a molded component. In an alternative design of the protective hood it can also be provided that the counter-body and/or the further counter-body are arranged as separate components on the protective hood. This is provided particularly if the protective hood is manufactured from metal sheets.

It is preferably provided that the work apparatus has an arm with a proximal end and a distal end, wherein the arm is secured to the housing with its proximal end and wherein the tool can be arranged on the distal end the tool, wherein the end stop is formed in particular integrally on the arm. The arm is preferably a molded component, in particular made of molded metal. In such an embodiment it is cost-effective to provide the end stop already on the molded component. Furthermore, an integral design of the end stop with the arm can enhance the strength of the end stop.

It is advantageously provided that the protective hood comprises a first outer side, a second outer side and a peripheral side, wherein the first outer side and the second outer side are connected to one another via the peripheral side, wherein the counter-body corresponding to the operating stop is arranged on the peripheral side. The peripheral side has the maximum distance to the axis of rotation of the tool and therefore also to the pivot axis of the protective hood. The axis of rotation of the tool corresponds to the pivot axis the protective hood. The counter-body thus forms a loading point for the operating stop, which has high leverage in view of the maximum distance to the pivot axis.

Furthermore, the further counter-body corresponding to the end stop is secured to the first outer side or to the second outer side of the protective hood. The counter-body and the further counter-body are thus arranged spaced apart from each other. The protective hood has a radius in relation to the axis of rotation, wherein the distance between the end stop and the axis of rotation is at most 60% of the radius. Analogously, the distance between the further counter-body and the axis of rotation is also in particular at most 60% of the radius of the protective hood. The closer the end stop and/or the further counter-body are arranged to the axis of rotation of the tool or to the pivot axis of the protective hood, the lower the leverage effect with respect to the loading point on the protective hood. However, this also reduces the impact speed of the further counter-body on the end stop. If, therefore, the further counter-body and the end stop collide at reduced speed, the elastic and/or plastic deformation also occurs at a lower strain rate. The lower the strain rate during a deformation process, the lower also the stress that occurs in the region of the deformation of the component. This is intended to prevent component failure of the end stop and the further counter-body. Particularly preferably, the distance of the end stop and/or of the further counter-body is at most 50%, very particularly at most 40% of the radius of the protective hood.

It is preferably provided that the end stop and the further counter-body are designed in such a way that, on mutual contact, they have a contact surface that extends radially to the axis of rotation over at least 10% of the radius of the protective hood. This is intended to ensure a sufficiently large contact surface, which in turn causes the lowest possible surface pressure. The low surface pressure in turn leads to deformations with less strain and thus also with lower stress.

It is provided in particular that the work apparatus has a motor support unit to which the drive motor and the housing of the work apparatus are attached, wherein the operating stop is arranged on the motor support unit. The motor support unit of the handheld work apparatus is a component with particularly high strength and rigidity. This ensures that the drive motor, in particular the individual components thereof, are positioned as accurately as possible in the housing, thereby ensuring the drive function of the drive motor. By forming the operating stop on the motor support unit, it can be ensured that high forces and torques can be transferred from the protective hood to the motor support unit via the counter-body and the operating stop. By forming the operating stop on the motor support unit, the kinetic energy of the parts of the tool that are captured in the protective hood, in particular of cutting wheel, can be transferred to the motor support unit.

It is provided in particular that the operating stop, the end stop, the counter-body and/or the further counter-body are formed from a metal alloy. Thus, the aforementioned components are very strong in particular compared to plastic designs. Thus, the pivoting movement of the protective hood can be reliably stopped or restricted.

It is provided in particular that the work apparatus has a first stop surface formed on the operating stop and a second stop surface formed on the counter-body, which surfaces touch each other in a common contact surface when the operating stop and counter-body make contact. The first stop surface and the second stop surface are designed in such a way that their surfaces make full contact when they come into mutual contact. The surface pressure on the stop surfaces can thus be kept as low as possible to stop the components from getting damaged. It is in particular provided that the contact surface spans a contact plane, and that the contact plane intersects the tool at a contact line on a tool circumference of the tool and makes an angle with a tangent plane of the tool that touches the tool at the contact line. This angle is open in the direction of rotation of the tool. The angle is in particular less than 90°, in particular less than 80°. As a result, the operating stop and the counter-body interlock. In other words, the operating stop and the counter-body are hooked together. It can thus be ensured that the counter-body on the protective hood does not slide off the operating stop on the motor support unit. The abovementioned angle is in particular more than 55°, preferably more than 65°, in particular more than 70°. This ensures that the wedge effect that occurs, i.e. the force components that are aligned vertical to the surface normal of the contact surface, do not become too large and do not damage the operating stop or the counter-body. Moreover, notch effects may also occur due to an angle that is too acute. Particularly advantageously, the contact surface is parallel to a plane which is spanned by the longitudinal centre axis of the arm and by an axis of rotation of the tool.

### BRIEF DESCRIPTION OF THE DRAWINGS

An exemplary embodiment is explained hereinafter with reference to the drawing, which shows:

FIG. 1 shows, in a perspective illustration, an embodiment of the handheld work apparatus,

FIG. 2 shows, in a side view, the handheld work apparatus according to FIG. 1,

FIG. 3 shows, in a side view, the handheld work apparatus according to FIG. 1 without a tool and partially without the arm being covered,

FIG. 4 shows, in a cutaway side illustration, the arm of the work apparatus according to FIG. 1 with pulley and belt

FIG. 5 shows, in a side illustration, the work apparatus 1 according to FIG. 1 in the second operating position,

FIG. 6 shows, in a side illustration, the work apparatus 1 according to FIG. 1 schematically in the first operating position and in the second operating position,

FIG. 7 shows, in a perspective illustration, the protective hood of the work apparatus according to FIG. 1,

FIG. 8 shows, in a perspective illustration, the motor support unit of the work apparatus according to FIG. 1,

FIG. 9 shows, in an illustration from below, the work apparatus according to FIG. 1,

FIG. 10 shows, in a lateral, enlarged illustration, the operating stop and counter-body of the work apparatus according to FIG. 1 in contact,

FIG. 11 shows, in a perspective illustration, the arm of the work apparatus according to FIG. 1,

FIG. 12 shows, in a side illustration, the arm according to FIG. 11,

FIG. 13 shows, in a side illustration, the protective hood according to FIG. 7,

FIG. 14 shows, in a side illustration, the work apparatus according to FIG. 1 with protective hood in the end position shown transparently,

FIG. 15 shows, in a perspective illustration, an alternative embodiment of the motor support unit with operating stop,

FIG. 16 shows, in a front view, the motor support unit according to FIG. 15,

FIG. 17 shows, in a cutaway sectional illustration along the section line between the arrows XVII, the motor support unit according to FIG. 15,

FIG. 18 shows, in a perspective illustration, a further alternative embodiment of the motor support unit with operating stop,

FIG. 19 shows, in a front view, the motor support unit according to FIG. 18, and

FIG. 20 shows, in a cutaway sectional illustration along the section line between the arrows XX, the motor support unit according to FIG. 18.

### DETAILED DESCRIPTION

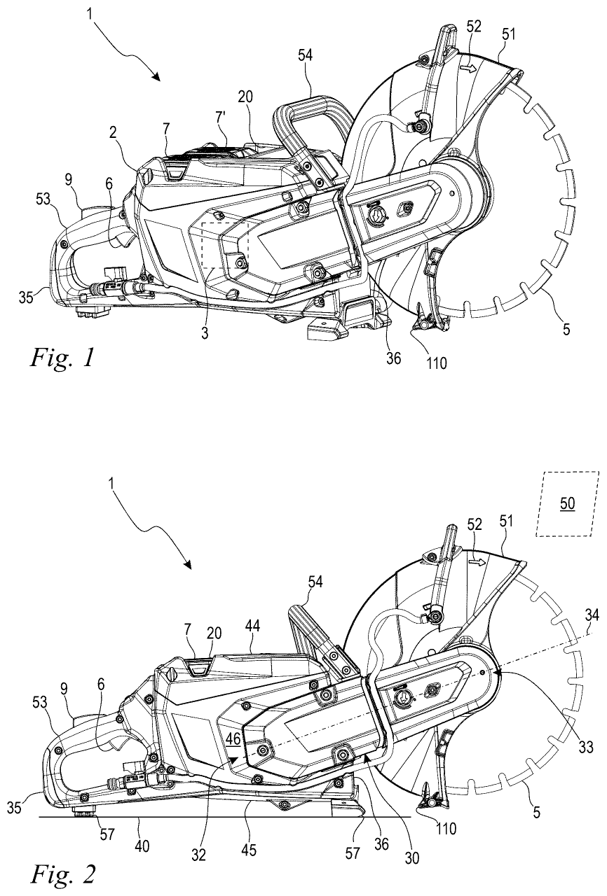

FIG. 1 shows an exemplary embodiment of the handheld work apparatus 1 as a cut-off machine. The work apparatus 1 can alternatively also be designed as a chainsaw or as another work apparatus. The work apparatus 1 is handheld, in particular hand-carried. The work apparatus 1 is carried and controlled by the operator during operation. The work apparatus 1 has a housing 2. Furthermore, the work apparatus 1 comprises a drive motor 3, the drive motor 3 being arranged in the housing 2. In FIG. 1, the drive motor 3 is shown merely schematically by way of a dashed square. In the present exemplary embodiment, the drive motor 3 is an electric motor. In an alternative embodiment, the drive motor 3 can also be an internal combustion engine. The drive motor 3 is used for driving a tool 5 that can be arranged on the work apparatus 1. In the present exemplary embodiment, the tool 5 is a cutting wheel.

As shown in FIG. 1, the work apparatus 1 comprises at least one battery pack 7 for supplying the drive motor 3 with electrical power. Particularly preferably, the work apparatus 1 comprises a further battery pack 7′ for supplying the drive motor 3 with power. A receptacle housing 20 is provided for accommodating the at least one battery pack 7 and/or the further battery pack 7′. The receptacle housing 20 is arranged on the housing 2, in particular fixed thereon. In the present embodiment of the work apparatus 1, the receptacle housing 20 is designed as a component that is separate from the housing 2. In an alternative embodiment, it can also be provided that the receptacle housing 20 and the housing 2 are designed as a single piece, in particular the receptacle housing 20 is an integral part of the housing 2. The receptacle housing 20 comprises a first receptacle for receiving the at least one battery pack 7. Furthermore, the receptacle housing 20 comprises a second receptacle for receiving the further battery pack 7′. The battery packs 7, 7′ can be removed from the receptacle housing 20, in particular the receptacles, without using tools. To attach the battery packs 7, 7′ to the work apparatus 1, they are inserted into the receptacle housing 20, in particular into the receptacles, and clipped into place. This clip attachment can be released without using tools and the battery packs 7, 7′ can be removed from the receptacle housing 20, in particular from the receptacles, again, for example for charging or simply to replace them. The battery packs 7, 7′ can alternatively be designed as slide-in battery packs.

As shown in FIGS. 1 and 2, the work apparatus 1 comprises a rear handle 53. Furthermore, the work apparatus 1 comprises a front handle 54. The front handle 54 is preferably designed as a handle tube. Other configurations of the front handle 54 can also be expedient. The housing 2 extends from a rear end 35 up to a front end 36. The rear handle 53 forms in the present case the rear end 35 of the housing 2. In an alternative embodiment, it can also be provided that the rear handle 53 is designed to be separate from the housing 2. In such an embodiment, the rear handle 53 is arranged in the region of the rear end 35 of the housing 2. The front handle 54 is arranged in the region of the front end 36 of the housing 2.

In addition, the work apparatus 1 has a control element 6, the control element 6 being provided for controlling the drive motor 3. The control element 6 is designed as an operating lever. The control element 6 is assigned to the rear handle 53. Furthermore, the work apparatus 1 comprises a blocking element 9, which locks the control element 6 in a blocking position and releases the control element 6 for actuation in an enable position. The blocking element 9 is preferably designed as a blocking lever. The blocking as well as the enable function performed by the blocking element 9 can take place mechanically and/or electronically, for example by means of sensors. The blocking element 9 is assigned to the rear handle 53. This means that when the operator grips the rear handle 53, they can actuate the control element 6 as well as the blocking element 9. In the preferred exemplary embodiment, the control element 6 and the blocking element 9 are arranged on the rear handle 53.

Particularly preferably, the work apparatus 1 comprises a control unit, not shown in more detail. The control unit processes signals that are generated by the control element 6 and/or the blocking element 9 and is mainly used for controlling the drive motor 3. Other functions of the work apparatus 1 can also be implemented via the control unit.

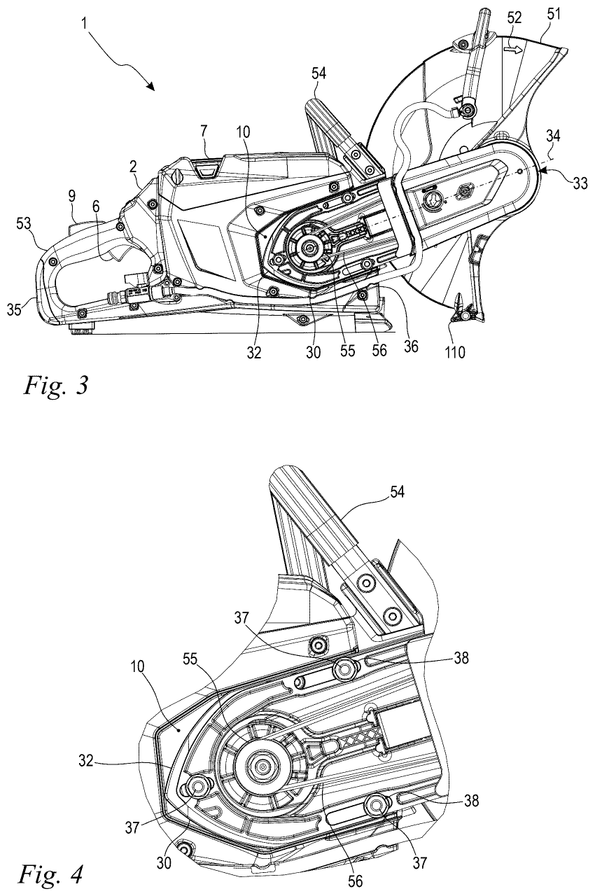

As shown in FIG. 3, the work apparatus 1 comprises an arm 30. The arm 30 extends along its longitudinal centre axis 34 from a proximal end 32 up to a distal end 33. The arm 30 is at least indirectly secured to the housing 2. The arm 30 is secured indirectly to the housing 2 in particular in the region of the front end 36 of the housing 2. The arm 30 protrudes beyond the front end 36 of the housing 2 and extends with its distal end 33 away from the front end 36 of the housing 2. The tool 5 can be arranged on the distal end 33 of the arm 30. The tool 5 is rotatably mounted on the distal end 33 of the arm 30. When the work apparatus 1 is in operation, the tool 5 is driven in rotation by the drive motor 3 in a direction of rotation 52 (FIGS. 1 and 2).

As shown in FIGS. 3 and 4, the work apparatus 1 comprises a pulley 55 that is driven via the drive motor 3. Furthermore, the work apparatus 1 comprises a further pulley (not shown in more detail) that is arranged at the distal end 33 of the arm 30 and is fixedly connected to the tool 5 in the direction of rotation 52 of the tool 5. Of course, the tool 5 as well as the further pulley can be detached, whereby they can each be replaced individually. The pulley 55, which is preferably arranged in the region of the proximal end 32 of the arm 30 on the housing 2, is operatively connected to the further pulley via a belt 56. The belt 56 is used for transmitting speed and torque between the drive motor 3 and the tool 5.

As shown in FIGS. 1 and 2, the work apparatus 1 comprises a protective hood 51. The protective hood 51 is attached to the arm 30, in particular to the distal end 33 of the arm 30. The protective hood 51 covers part of the circumference of the tool 5.

As shown in FIG. 2, the work apparatus 1 comprises a top side 44 and a bottom side 45, wherein the bottom side 45 of the work apparatus 1 can be set down on a floor 40. The top side 44 and the bottom side 45 are connected to one another by a first longitudinal outer side 46 and a second longitudinal outer side 47. Expressions which describe the sides or other components of the work apparatus 1 in terms of space, for example “top side” and “bottom side”, refer in principle in this case to the usual set-down position of the work apparatus 1 shown in FIG. 2. The usual set-down position of the work apparatus 1 is a position in which the work apparatus 1 is set down on a flat, horizontal set-down surface. Feet 57 are used for setting down the work apparatus 1.

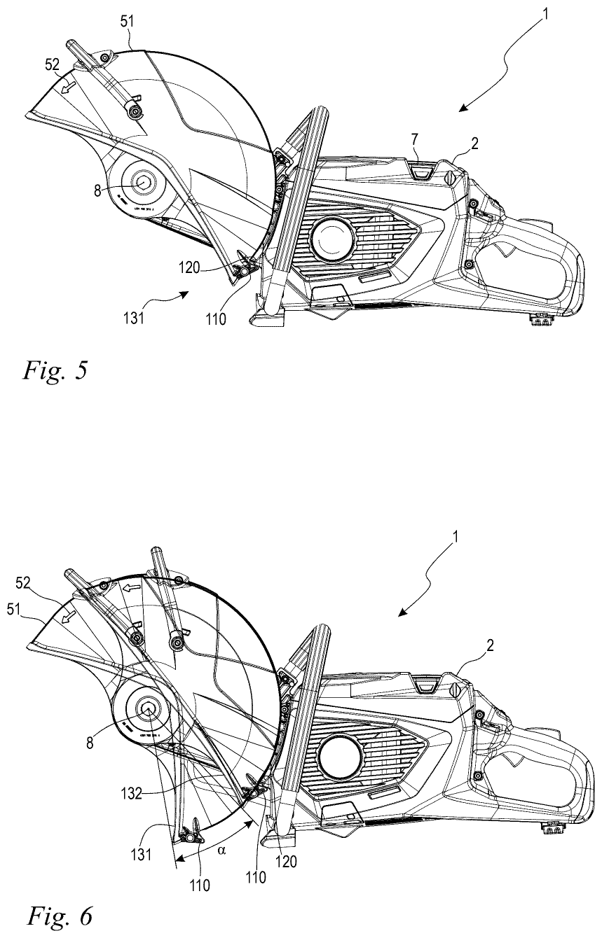

As shown in the FIGS. 5 and 6, the work apparatus 1 comprises an operating stop 120. The operating stop 120 is fixed to the housing 2. A counter-body 110 corresponding to the operating stop 120 is arranged on the protective hood 51. The operating stop 120 and the counter-body 110 are designed for mechanical interaction in order to restrict a pivoting movement of the protective hood 51 from a first operating position 131 to a second operating position 132. The tool 5 is mounted so as to rotate about an axis of rotation 8. The protective hood 51 is mounted so as to pivot about an axis of rotation. The axis of rotation of the protective hood 51 corresponds to the axis of rotation 8 of the tool 5. As shown in FIG. 6, the protective hood 51 is able to pivot from the first operating position 131 into the second operating position 132. FIG. 6 schematically shows the protective hood 51 both in the first operating position 131 and in the second operating position 132, in order to illustrate a maximum pivot angle α of the protective hood 51 during normal operation of the work apparatus 1. In the first operating position 131, the operating stop 120 and the counter-body 110 are arranged spaced apart from each other. The operating stop 120 and the counter-body 110 do not come into contact. In the second operating position 132, the operating stop 120 and the counter-body 110 do come into contact, as also shown in FIG. 5.

As shown in FIG. 6, the protective hood 51 is able to pivot about the maximum pivot angle α. The maximum pivot angle α is the angle about which the protective hood 51 can be pivoted during normal operation of the work apparatus 1. The maximum pivot angle α extends, in relation to the axis of rotation 8, from the first operating position 131 to the second operating position 132. It is not intended for the protective hood 51 to pivot in the direction of rotation 52 of the tool 5 beyond the second operating position 132 during normal operation of the work apparatus 1. It is likewise not intended for the protective hood 51 to pivot counter to the direction of rotation 52 of the tool 5 beyond the first operating position 131, since in this direction a further operating stop (not shown in more detail) is provided. The maximum pivot angle α is preferably less than or equal to 90°, in particular less than 60°. The maximum pivot angle α of the protective hood 51 from the first operating position 131 to the second operating position 132 or from the second operating position 132 to the first operating position 131 is preferably at least 30°. The protective hood 51 can also be pivoted into intermediate positions that are not shown in more detail, with the intermediate positions lying between the first operating position 131 and the second operating position 132. The protective hood 51 can preferably be pivoted continuously into a corresponding intermediate position between the first operating position 131 and the second operating position 132. The protective hood 51 is preferably fixed in the corresponding intermediate position.

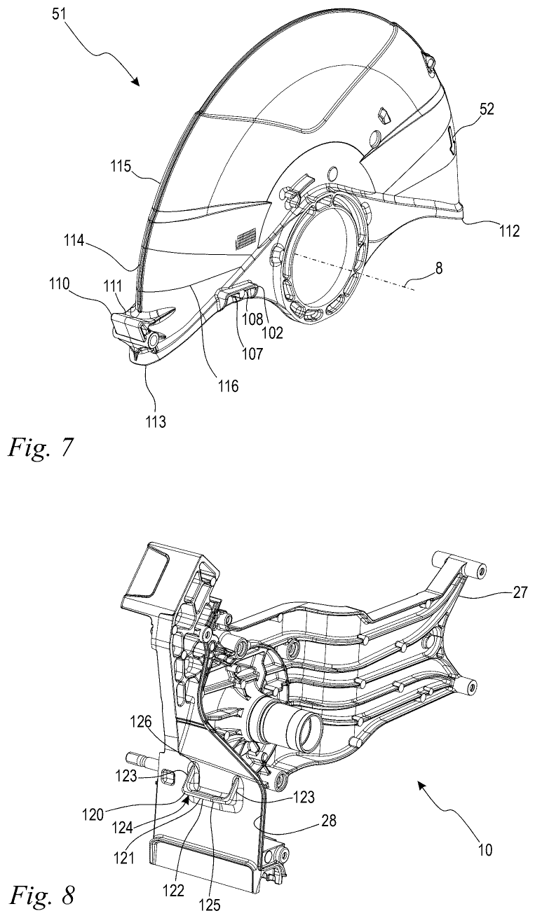

FIG. 7 shows the protective hood 51 on its own. The protective hood 51 extends from a first end 112 about the axis of rotation 8 up to a second end 113. The second end 113 is the end of the protective hood 51 which, both in the first operating position 131 and in the second operating position 132 of the protective hood 51, is arranged closer to the housing 2 (FIG. 6). Moreover, the second end 113 lies below the first end 112 of the protective hood 51. The counter-body 110 is preferably arranged adjacent to the end 113 of the protective hood 51. The protective hood 51 has a first outer side 115, a second outer side 116 as well as a peripheral side 114. The first outer side 115 and the second outer side 116 are connected to one another via the peripheral side 114. The main direction of extension of the first outer side 115 and the second outer side 116 of the protective hood 51 runs approximately parallel to the tool plane 50 (FIG. 2). The counter-body 110 is arranged on the peripheral side 114 of the protective hood 51. The counter-body 110 is preferably integral with the protective hood 51. The protective hood 51 is preferably a molded component. The protective hood 51 and the counter-body 110 are preferably formed from a single molded component. The protective hood 51 as well as the counter-body 110 are formed in particular from a metal alloy. Thus, the protective hood 51 together with the counter-body 110 has a high component strength. In an alternative embodiment, it can also be provided that the protective hood 51 is welded, screwed, riveted or, for example, clipped from sheet metal elements.

FIG. 8 shows the motor support unit 10 on its own. The motor support unit 10 is a constituent part of the work apparatus 1. The motor support unit 10 is designed separately from the housing 2. The drive motor 3 is preferably attached directly to the motor support unit 10. The housing 2 is likewise attached to the motor support unit 10.

As shown in FIG. 8, the motor support unit 10 is designed as a motor support plate. The motor support unit 10 extends from a rear end 27 up to a front end 28. The rear handle 53 is arranged on the rear end 27 of the motor support unit 10, in particular is attached thereto. The front handle 54 is arranged on the front end 28, in particular is attached thereto. The motor support unit 10 is preferably a molded part. The motor support unit 10 is preferably formed from a metal alloy, in particular from a magnesium alloy.

As shown in particular in FIG. 8, the operating stop 120 is arranged on the motor support unit 10, in particular on the front end 28 of the motor support unit 10. Particularly preferably, the operating stop 120 is integral with the motor support unit 10. As already stated above, the motor support unit 10 is designed in the preferred embodiment as a molded component. Therefore, the motor support unit 10 as well as the operating stop 120 form a single molded component.

As shown in FIGS. 7 to 10, the work apparatus 1 comprises a first stop surface 111 and a second stop surface 122. The first stop surface 111 is formed on the counter-body 110 of the protective hood 51. The second stop surface 122 is formed on the operating stop 120 of the motor support unit 10. In the second operating position 132 of the protective hood 51, the counter-body 110 rests with the first stop surface 111 against the second stop surface 122 of the operating stop 120. In the second operating position 132 of the protective hood 51, the first stop surface 111 and the second stop surface 122 come into contact in a contact surface 130. The first stop surface 111 and the second stop surface 122 are consequently designed such that they come into surface contact with the protective hood 51 in the second operating position 132.

FIG. 10 shows an enlarged view of the counter-body 110 and the operating stop 120 in mutual contact. The contact surface 130 spans a contact plane 140. The tool 5 is shown in FIG. 10 as a dashed line and has a tool circumference 141. The fact that such a tool 5 in the form, for example, of a cutting wheel does not have an ideally circular tool circumference should be understood as meaning a, in relation to the axis of rotation 8 of the tool 5, radially outermost contour of a rotary body specified by the tool 5. The contact plane 140 intersects the tool 5 at the tool circumference 141 of the tool 5 at a contact line that is not shown in more detail. At this contact line, the tool 5 has a tangent plane 142. In other words, the tool 5 has a tangent plane 142 that is tangent to the tool 5 at the tool circumference 141 at the mentioned contact line. Contact plane 140 and tangent plane 142 intersect at the contact line, thereby making an angle β. The angle β is open in the direction of rotation 52 of the tool 5 in relation to the contact line. The angle β is preferably less than or equal to 90°, in particular less than 80°. The angle β is in particular greater than 55°, in particular greater than 65°, particularly preferably greater than 70°. The angle β is selected such that the counter-body 110 and the operating stop 120 hook into each other. The protective hood 51 is pulled towards the motor support unit 10 by the above-described angular alignment of the contact zone when counter-body 110 and operating stop 120 come into contact. Nevertheless, the angle β is not so acute that the reaction forces of counter-body 110 and operating stop 120 are just high enough to prevent the counter-body 110 from breaking out of the protective hood 51.

As shown in FIG. 10, the first stop surface 111 on the counter-body 110 of the protective hood 51 is aligned in the direction of rotation 52 of the tool 5. The second stop surface 122 on the operating stop 120 of the motor support unit 10 is aligned counter to the direction of rotation 52 of the tool 5.

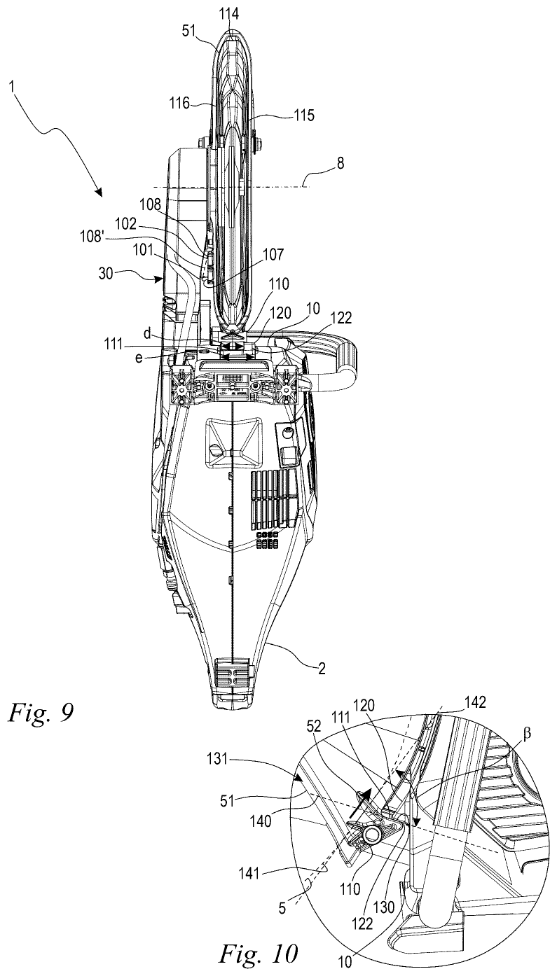

As shown in FIG. 9, the first stop surface 111 of the counter-body 110 has a width d measured in the direction of the axis of rotation 8 of the tool 5. The second stop surface 122 of the operating stop 120 has a width e measured in the direction of the axis of rotation 8 of the tool 5. The width e of the second stop surface 122 of the operating stop 120 is greater than the width d of the first stop surface 111 of the counter-body 110. The width e of the second stop surface 122 of the operating stop 120 corresponds to at least 1.2 times, preferably at least 1.3 times, in particular at least 1.4 times the width d of the first stop surface 111 of the counter-body 110 of the protective hood 51. Particularly preferably, the width e of the second stop surface 122 of the operating stop 120 corresponds to approximately 1.5 times the width d of the first stop surface 111 of the counter-body 110 of the protective hood 51. The width d of the first stop surface 111 of the counter-body 110 is less than the width of the base body of the protective hood 51, which is specified by the maximum distance, measured in the direction of the axis of rotation 8 of the tool 5, between the first outer side 115 and the second outer side 116 of the protective hood 51.

As shown in FIG. 9, the first stop surface 111 of the counter-body 110 and the second stop surface 122 of the operating stop 120 are arranged in relation to each other in such a way that their ends facing the arm 30 are arranged approximately in the same position approximately in relation to a direction of the axis of rotation 8 of the tool 5. Since the second stop surface 122 is wider than the first stop surface 111, the end, facing away from the arm 30, of the second stop surface 122 has a significantly greater distance from the arm 30 than the end, facing away from the arm 30, of the first stop surface 111. It is thus ensured that even if the protective hood 51 is deformed, for example by vibrations of the protective hood 51, the counter-body 110 with its entire first stop surface 111 comes to rest on the second stop surface 122 of the operating stop 120. The protective hood 51 typically deforms away from the arm 30 since this forms a single-sided stop for the protective hood 51.

As shown in FIG. 8, the operating stop 120 is formed from a stop wall 124 and two outer ribs 123. The stop wall 124 forms a projection with respect to the base body of the motor support unit 10. The stop wall 124 is supported at both its ends against the base body of the operating stop 120 in each case by an outer rib 123. The stop wall 123 has a bottom side 125 and a top side 126 opposite the bottom side 125. The second stop surface 122 of the operating stop 120 is formed on the bottom side 125 of the stop wall 123. Between the two outer ribs 123 is the top side 126 the stop wall 124 free of further reinforcing structures. Thus, due to the lack of further reinforcing structures, the stop wall 124 forms a potential predetermined breaking point 121. The operating stop 120 is designed in such a way that it reliably restricts the pivoting movement of the protective hood 51, executed by the operator by hand. Both the counter-body 110 and the operating stop 120 have a sufficiently high component strength for this purpose. However, if the protective hood 51 strikes the operating stop 120 with its counter-body 110 with significantly greater kinetic energy, for example during a burst test, the predetermined breaking point 121 on the operating stop 120 is meant to ensure that the operating stop 120 breaks to protect the counter-body 110 on the protective hood 51, but the counter-body 110 does not break. Thus, the predetermined breaking point 121 on the operating stop 120 forms a type of excess load protection for the counter-body 110. The operating stop 120 moreover serves as an energy absorption element. In the event of an excess load acting on the operating stop 120 due to the counter-body 110, the operating stop 120 moves away from the counter-body 110 in order to absorb kinetic energy of the protective hood 51 and to protect components of the counter-body 110. This takes place in the preferred exemplary embodiment by the operating stop 120 breaking at the predetermined breaking point 121 of the stop wall 124. The counter-body 110 moves through the operating stop 120. Therefore, the counter-body 110 has a higher component strength than the operating stop 120.

If the operating stop 120 has moved away from the counter-body 110, the protective hood 51 probably has residual kinetic energy. Consequently, the protective hood 51 will rotate further in the direction of movement 52 of the tool 5. In order to now restrict the rotational movement of the protective hood 51 to an end position 25, the work apparatus 1 comprises an end stop 101. The end stop 101 is fixed to the housing 2.

As shown in FIG. 7, the protective hood 51 comprises a further counter-body 102. The further counter-body 102 is designed to correspond to the end stop 101. The further counter-body 102 is preferably formed integrally on the protective hood 51. The further counter-body 102 is preferably formed on one of the two outer sides 115, 116 of the protective hood 51. Preferably, the further counter-body 102 is formed on the second outer side 116 of the protective hood 51. The second outer side 116 is that outer side of the protective hood 51 that faces towards the arm 30.

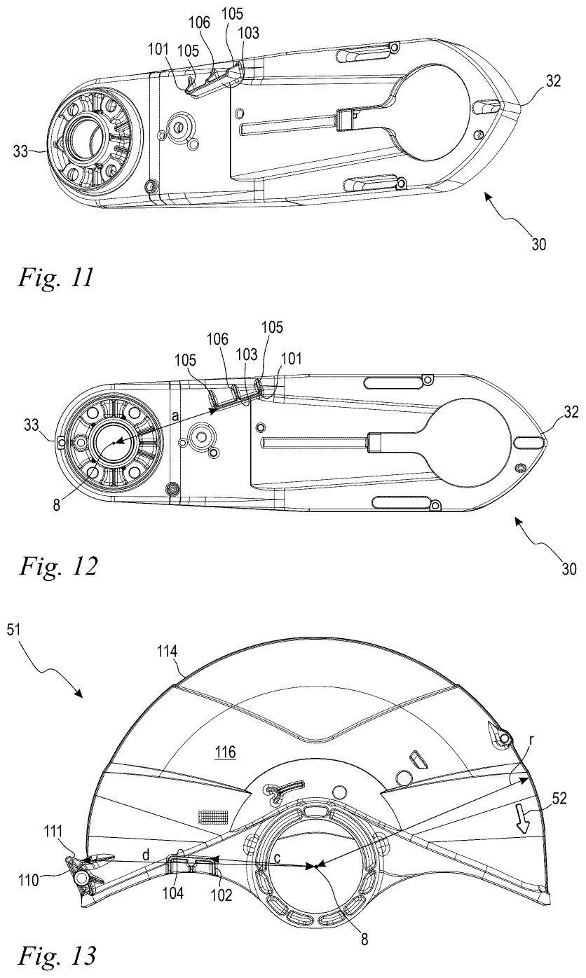

As shown in FIGS. 11 and 12, the end stop 101 is formed on the arm 30. The end stop 101 is preferably formed integrally on the arm 30. Therefore, the end stop 101 and the arm 30 are preferably designed as a single piece. The arm 30 is preferably a molded component. The arm 30 preferably consists of a metal alloy. As already mentioned above, the operating stop 120, the end stop 101, the counter-body 110 and/or the further counter-body 102 are thus formed from a metal alloy.

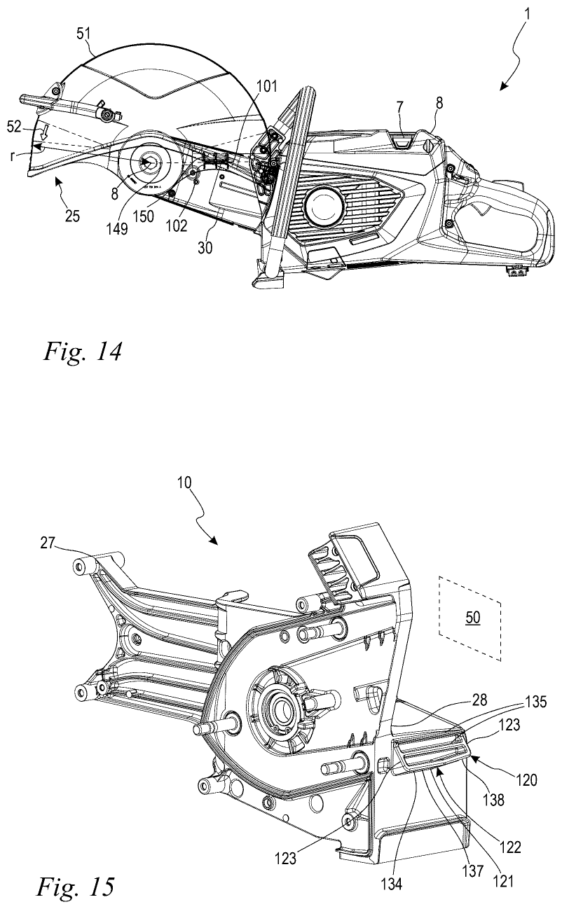

As shown in FIGS. 11 to 13, the end stop 101 comprises a third stop surface 103. The further counter-body 102 comprises a fourth stop surface 104. If the protective hood 51 rotates so far in the direction of rotation 52 that the further counter-body 102 of the protective hood 51 comes to rest against the end stop 101 of the arm 30, they touch each other in a further contact surface 150 (FIG. 14). The further contact surface 150 is formed from the contact area of the third stop surface 103 of the end stop 101 and in the fourth stop surface 104 of the further counter-body 102. The third stop surface 103 of the end stop 101 and the fourth stop surface 104 of the further counter-body 102 are aligned substantially parallel to each other.

As shown in FIG. 13, the protective hood 51 comprises a radius r in relation to the axis of rotation 8. Such a protective hood 51 does not have an ideally circular hood circumference. Therefore, the hood circumference is to be understood as a contour that is radially outermost in relation to the axis of rotation 8 and that is predefined by a rotating body, which in turn is formed from a base body of the protective hood, consisting of both outer sides 115, 116 and the peripheral side 114 of the protective hood. Handles of the protective hood as well as any stops or counter-bodies are not part of the base body of the protective hood 51. The counter-body 110 as well as the further counter-body 102 are arranged spaced apart from each other. The counter-body 110 of the protective hood 51, in particular the first stop surface 111 of the counter-body 110 of the protective hood 51, has a distance d to the axis of rotation 8. The further counter-body 102, in particular the fourth stop surface 104 of the further counter-body 102, has a distance c to the axis of rotation 8. The distance c between the axis of rotation 8 and the further counter-body 102 is less than the distance d between the counter-body 110 and the axis of rotation 8. The distance c between the axis of rotation 8 and the further counter-body 102 corresponds to at most 50% of the distance d between the axis of rotation 8 and the counter-body 110.

As shown in FIG. 12, the end stop 101, in particular the third stop surface 103 of the end stop 101, has a distance a to the axis of rotation 8. The distance a between the end stop 101 and the axis of rotation 8 is at most 60%, in particular at most 50%, very particularly at most 40% of the radius r of the protective hood 51.

FIG. 14 shows the work apparatus 1 with a protective hood 51 indicated by a dotted line. The protective hood 51 is located in an end position 25. In the end position 25 of the protective hood 51, the further counter-body 102 and the end stop 101 of the arm 30 make contact with each other in the further contact surface 150. The contact surface 150 extends radially to the axis of rotation 8 over a minimum length that corresponds to at least 10% of the radius r of the protective hood 51. The further contact surface 150 in turn spans a further contact plane 149, which substantially corresponds to a radial plane of the axis of rotation 8. Thus, the axis of rotation 8 lies completely in the contact plane 149.

As shown in FIGS. 11 and 12, the end stop 101 has a rib 105 at each of its ends that are radial in relation to the axis of rotation 8, which ribs support the end stop 101 against the base body of the arm 30. To increase strength, the end stop 101 has a further support rib 106 between the two ribs 105, which serves to support the end stop 106 on the arm 30.

In an alternative embodiment of the work apparatus 1, it can also be provided that the operating stop 120 comprises a pretensioned stop element, which is arranged on the motor support unit 10 or on the housing 2. The pretensioned stop element is designed to be pivotable and such that it moves away from the counter-body 110 when it is hit by the counter-body 110. For this purpose, the counter-body 110 must overcome the pretension of the stop element that is preferably caused by a spring element. In the process, the stop element absorbs kinetic energy of the protective hood 51. The stop element would therefore not break away, but would pivot to the side to overcome the pretension. The protective hood 51 could then be pivoted back into an operating position pivoted are, without being broken or otherwise damaged.

In a further alternative embodiment of the work apparatus 1, it could also be provided that the operating stop 120 comprises a particularly ductile element which would plastically deform upon impact of the counter-body 110, but would not break.

Moreover, the operating stop 120 could also be supplemented by a brake which would brake the protective hood 51. Other designs of the operating stop 120 which cause the kinetic energy of the protective hood 51 to be absorbed are also conceivable.

In a further, alternative configuration of the work apparatus 1 it is provided, analogously to the shown embodiments, to also provide stops and counter-bodies, which enable the work apparatus 1 to be operated with two directions of rotation of the tool 5.

As shown in FIGS. 7 and 9, the further counter-body 102 of the protective hood 51 has an exposed end 107 that faces away from the second outer side 116 of the protective hood 51. The exposed end 107 faces towards the arm 30. The exposed end 107 is formed by an edge 108 of the further counter-body 102. The edge 108 of the exposed end 107 of the further counter-body 102 is aligned approximately parallel to the second outer side 116 of the protective hood 51. In other words, the edge 108 of the exposed end 107 of the further counter-body 102 lies completely in a plane that is aligned parallel to the tool plane 50. In an alternative, preferred embodiment of the protective hood 51, the exposed end 107 of the further counter-body 102 is provided with an edge 108′ which is adapted to the outer contour of the arm 30. Thus an ideally large overlap, measured in the direction of the axis of rotation 8, can be achieved between the end stop 101 and the further counter-body 102 without the further counter-body 102 striking the base body of the arm 30. Such an edge 108′ of the further counter-body 102 which is adapted to the arm 30 is shown in FIG. 7 as a dashed line. The adapted edge 108′ of the further counter-body 102 runs obliquely to the tool plane 50 in the dashed, schematically indicated embodiment. Other contours of the free end 107 of the counter-body 102 are also conceivable, which are adapted to the contour of the arm 30.

FIGS. 15 to 17 show a further embodiment of the motor support unit 10. The same reference signs designate the same components of the motor support unit 10. This motor support unit 10 differs from the motor support unit according to FIG. 8 substantially in the configuration of the operating stop 120. The operating stop 120 has in this embodiment two outer ribs 123, the main direction of extension of which runs in a plane aligned parallel to the tool plane 50. Ribs 123 having such a main direction of extension are referred to hereinafter as longitudinal ribs.

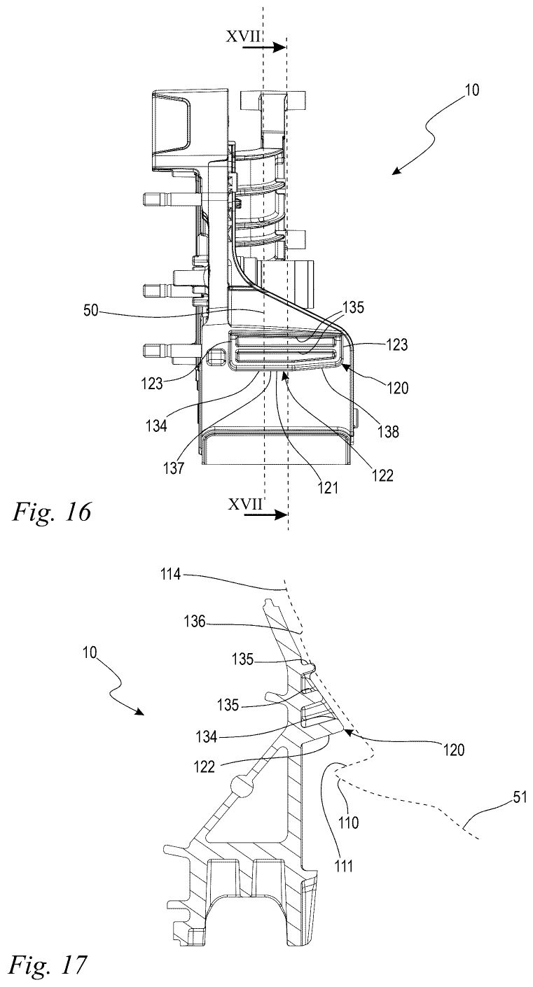

As shown in FIGS. 15 and 16, the two longitudinal ribs 123 are designed as outer ribs and delimit the operating stop 120 in the direction of the axis of rotation 8 of the tool 5. Furthermore, the operating stop 120 comprises a first transverse rib 134 as well as at least one further transverse rib 135. In the present embodiment, two further transverse ribs 135 are provided on the operating stop 120. A different number of further transverse ribs can also be expedient. The multiple transverse ribs 134, 135 have a main direction of extension, which corresponds to the direction of the axis of rotation 8 of the tool 5. The second stop surface 122 of the operating stop 120 is formed on the first transverse rib 134. Since the two longitudinal ribs 123 are only arranged on the outer ends of the transverse ribs 134, 135, the strength of the operating stop 120 in the middle area of the first transverse rib 134 is reduced. The structural rigidity is thus reduced in the middle area 121. If, for example, when the tool 5 ruptures, the counter-body 110 hits the second stop surface 122 of the operating stop 120 with its first stop surface 111, the second stop surface may deform due to the reduced strength owing to the lack of additional longitudinal ribs. In the process, the kinetic energy of the protective hood 51 is at least partially, in particular fully, dissipated. In the event of only partial energy dissipation, the counter-body 110 of the protective hood 51 contacts the at least one further transverse rib 135. If the second transverse rib 135 is also deformed by the counter-body 110, the latter would also collide with the third transverse rib 135. The work apparatus 1 is designed such that if all of the transverse ribs 134, 135 of the operating stop 120 deform due to particularly high kinetic energy of the protective hood 51, the protective hood 51 reaches at least its end position via contact between the further counter-body 102 and the end stop 101. Due to the deformation of the transverse ribs 134, 135, the kinetic energy of the protective hood 51 is gradually dissipated, whereby the maximum forces acting on the protective hood 51 are reduced.

FIG. 17 shows the motor support unit 10 in a cutaway sectional illustration with the section line XVII according to FIG. 16. The protective hood 51 with its counter-body 110 is schematically indicated using a dashed line. One of the transverse ribs 134, 135, in the present case the third transverse rib 135, is designed in such a way that if the tool 5 ruptures, said rib contacts the peripheral side 114 of the protective hood 51, even before the counter-body 110 of the protective hood 51 hits the operating stop 120 of the motor support unit 10. When the tool 5 ruptures, the protective hood 51 can elastically deform and deflect at the interface between the protective hood 51 and the arm 30. As a result, the peripheral side 114 contacts the corresponding transverse rib 135. This means that energy is dissipated due to the contact between the peripheral side 114 of the protective hood 51 and the corresponding transverse rib 135 of the operating stop 120, even before the counter-body 110 of the protective hood 51 hits the operating stop 120 of the motor support unit 10. The collision energy of the two stops is thus reduced. The corresponding transverse rib 135, which is intended to contact the peripheral side 114 of the protective hood 51, has in the operating state, apart from when the tool 5 ruptures, a shorter distance to the peripheral side 114 of the protective hood 51 than the other transverse ribs 134, 135. It can alternatively also be provided that multiple transverse ribs 134, 135 are designed to make contact with the protective hood 51 on the peripheral side, in the event of the tool rupturing. In particular, a ridge 136 is formed on the protective hood 51, which ridge is provided as a projection on the peripheral side 114 of the protective hood 51. Thus, in present embodiment, the ridge 136 of the protective hood 51 contacts the corresponding transverse rib 135 of the operating stop 120.

It is shown in FIGS. 15 and 16 that the second stop surface 122 of the operating stop 120 is divided into a main surface 137 and a secondary surface 138. The main surface 137 is aligned perpendicular to the tool plane 50 of the work apparatus 1. If the protective hood 51 rotates in the tool plane 50, the first stop surface 111 of the counter-body 110 of the protective hood 51 contacts the operating stop 120 in its main surface 137.

The secondary surface 138 of the second stop surface 122 directly adjoins the main surface 137 of the second stop surface 122. The main surface 137 is aligned in such a way that it is intersected by the tool plane 50. The secondary surface 138 of the second stop surface 122 lies outside the tool plane 50. However, the secondary surface 138 and the main surface 137 are not aligned parallel to one another. The secondary surface 138 has a slope with respect to the main surface 137. The slope is in the present embodiment approximately 5°. If the tool 5 ruptures, then the protective hood 51, as described above can deform and deflect at the interface to the arm 30. Typically, the protective hood 51 deforms in such a way that this it deforms at its bottom side towards the first longitudinal side 115 and at its top side towards the second longitudinal side 116. As a result, the plane of rotation of the protective hood 51 pivots relative to the original tool plane 50, whereby the first stop surface 111 of the counter-body 110 and the main surface 137 of the second stop surface 122 of the operating stop 120 no longer make full area contact. In this deformed state, the first stop surface 111 of the counter-body 110 hits the secondary surface 138 of the second stop surface 122 of the operating stop 120. Due to the sloped alignment of the secondary surface 138, the secondary surface 138 and the first stop surface 111 of the counter-body 110 are in contact over as large an area as possible. This ensures the transmission of force over a large surface area.

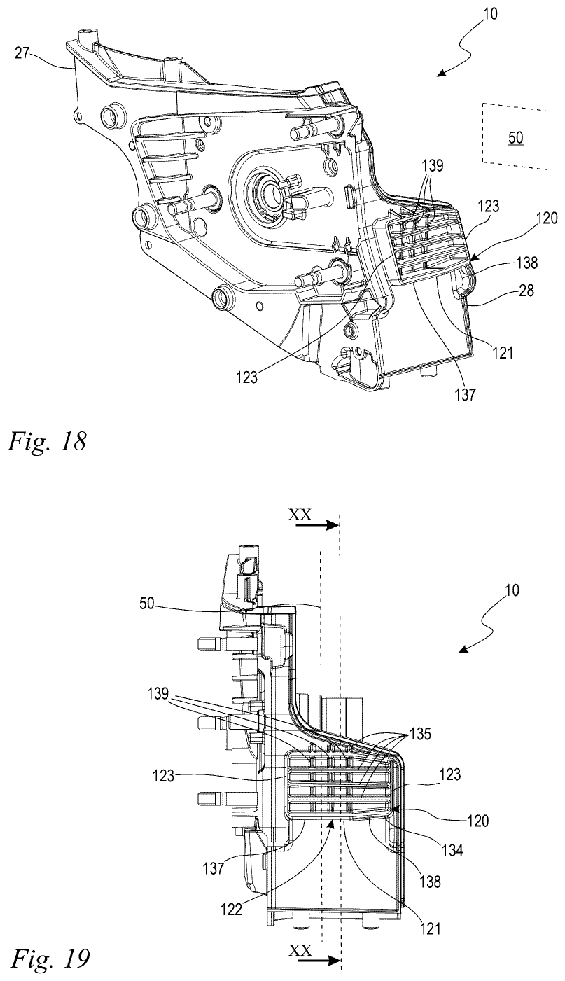

FIGS. 18 to 20 show an additional embodiment of the motor support unit 10. The same reference signs designate the same components of the motor support unit 10. The operating stop 120 comprises multiple transverse ribs 135 in addition to the first transverse rib 134. There are four transverse ribs 135 in this exemplary embodiment. The kinetic energy of the protective hood 51 can thus be dissipated when the first transverse rib 134 as well as the multiple transverse ribs 135 deform.

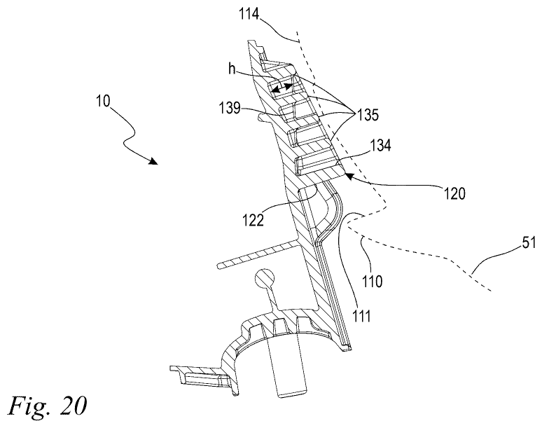

A significant difference from the embodiment according to FIGS. 15 to 17 lies in the configuration of the longitudinal ribs 123, 139. The operating stop 120 comprises outer longitudinal ribs 123, which enclose the transverse ribs 134, 135 at their ends. Thus, the two outer longitudinal ribs 123 form a partial frame for the operating stop 120. Furthermore, the operating stop 120 comprises inner longitudinal ribs 139. In the present embodiment, the operating stop 120 comprises multiple inner longitudinal ribs 139, in particular three inner longitudinal ribs 139. A different number of inner longitudinal ribs 139 can also be expedient. The inner longitudinal ribs 139 extend, as do in particular the outer longitudinal ribs 133, from the first transverse rib 134 across all transverse ribs 135. The inner longitudinal ribs 139 have a height h, as shown in FIG. 20. The height h is measured orthogonal to the base of the operating stop 120 on which the inner longitudinal ribs 139 are arranged. The height h of each inner longitudinal rib 139 increases in particular linearly in its longitudinal direction starting from the first transverse rib 134 to the last transverse rib 135. Due to the increase in the height h of the inner longitudinal ribs 139 in their longitudinal direction, the distance between the inner longitudinal rib 139 and the protective hood 51 is also reduced. The inner longitudinal ribs 139 of the operating stop 120 are designed and arranged in such a way that the counter-body 110 subsequently contacts the inner longitudinal ribs 139 when the first transverse rib 134 deforms. The further the counter-body 110 turns into the operating stop 120, the greater the resistance by the inner longitudinal ribs 139 against the rotational movement of the protective hood 51. The inner longitudinal ribs 139 effect a type of wedge effect against the counter-body 110, which counteracts any further rotation of the protective hood 51. Thus, the kinetic energy of the protective hood 51 is dissipated via the counter-body 110 making contact with the transverse ribs 134, 135 of the operating stop 120 on the one hand and with the inner longitudinal ribs 139 of the operating stop 120 on the other hand.

The second stop surface 122 of the operating stop 120 is divided into a main surface 137 and a secondary surface 138, just like in the embodiments of the motor support unit according to FIG. 8 as well as according to FIGS. 15 to 17.

1.-10. (canceled)

11. A handheld work apparatus, comprising:
a housing (2);
a drive motor (3) arranged in the housing (2) for driving a tool (5) that rotates about an axis of rotation (8);
a protective hood (51), the protective hood (51) at least partially covering the tool (5);
an operating stop (120) fixed relative to the housing (2);
an end stop (101) for restricting a rotational movement of the protective hood (51) to an end position (25); and
a counter-body (110) arranged on the protective hood (51) and corresponding to the operating stop (120),
wherein the operating stop (120) is an energy absorption element, and
wherein the energy absorption element, in an event of an excess load acting on the operating stop (120) due to the counter-body (110), moves away from the counter-body (110) in order to absorb kinetic energy of the protective hood (51) and to protect components of the counter-body (110).

12. The handheld work apparatus according to claim 11,
wherein a further counter-body (102) corresponding to the end stop (101) is provided on the protective hood (51), and
wherein the further counter-body (102) is integrally formed on the protective hood (51).

13. The handheld work apparatus according to claim 11, further comprising
an arm (30) with a proximal end (32) and a distal end (33),
wherein the arm (30) is secured to the housing (2) with the proximal end (32),
wherein the tool (5) can be arranged on the distal end (33), and
wherein the end stop (101) is formed integrally on the arm (30).

14. The handheld work apparatus according to claim 12,
wherein the protective hood (51) comprises a first outer side (115), a second outer side (116), and a peripheral side (114),
wherein the first outer side (115) and the second outer side (116) are connected to one another via the peripheral side (114), and
wherein the counter-body (110) corresponding to the operating stop (120) is arranged on the peripheral side (114).

15. The handheld work apparatus according to claim 14,
wherein the further counter-body (102) corresponding to the end stop (101) is secured to the first outer side (115) or to the second outer side (116) of the protective hood (51).

16. The handheld work apparatus according to claim 14,
wherein the protective hood (51) has a radius (r) in relation to the axis of rotation (8),
wherein a distance (a) between the end stop (101) and the axis of rotation (8) is at most 60% of the radius (r) of the protective hood (51).

17. The handheld work apparatus according to claim 16,
wherein the end stop (101) and the further counter-body (102) are designed in such a way that, on mutual contact, they have a contact surface (150) that extends radially to the axis of rotation (8) over at least 10% of the radius (r) of the protective hood (51).

18. The handheld work apparatus according to claim 14, further comprising
a motor support unit (10),
wherein the drive motor (3) and the housing (2) are attached to the motor support unit (10), and
wherein the operating stop (120) is arranged on the motor support unit (10).

19. The handheld work apparatus according to claim 12,
wherein the operating stop (120), the end stop (101), the counter-body (110) and/or the further counter-body (102) are formed from a metal alloy.

20. The handheld work apparatus according to claim 11, further comprising
a first stop surface (122) formed on the operating stop (120) and a second stop surface (111) formed on the counter-body (110),
wherein the first stop surface (122) and the second stop surface (111) touch each other in a common contact surface (130) when the operating stop (120) and counter-body (110) make contact,
wherein the common contact surface (130) spans a contact plane (140), and
wherein the contact plane (140) intersects the tool (5) at a contact line on a tool circumference (141) of the tool (5) and makes an angle (β) with a tangent plane (142) of the tool (5) that touches the tool (5) at the contact line,
wherein the angle (β) is open in a direction of rotation (52) of the tool (5), and
wherein the angle (β) is less than or equal to 90°.
